(19) United States
(12) Patent Application Publication
(10) Pub. No.: US 2016/0377169 A1
(43) Pub. Date: Dec. 29, 2016

(54) JOURNAL SEAT WITH OPTIMIZED PRESSURE DISTRIBUTION

(71) Applicants: ZF Friedrichshafen AG, Friedrichshafen (DE); ZF WIND POWER ANTWERPEN N.V., Lommel (BE)

(72) Inventor: Erwin van EYNDHOVEN, Aartselaar (BE)

(21) Appl. No.: 15/038,820

(22) PCT Filed: Nov. 18, 2014
(86) PCT No.: PCT/EP2014/074834

§ 371 Date: May 24, 2016

(30) Foreign Application Priority Data
Dec. 18, 2013 (DE) 10 2013 226 526.3

(51) Int. Cl. F16H 57/08

(52) U.S. Cl. CPC F16H 57/082

(57) ABSTRACT

A planetary carrier (101) has at least one first recess (103) and a second recess for receiving a planetary bolt (105). The carrier is based on the idea of increasing the rigidity of the planetary carrier (101) in the area of the first recess (103) by configuring the planetary carrier (101), around the first recess (103), more robustly than around the second recess. Correspondingly, a first cross-section (205), extending in the radial direction through the planetary carrier (101), has a larger area than a second cross-section (207) extending radially through the planetary carrier (101). The first recess (103) extends through the first cross-section (205) and the second cross-section (207), and the first cross-section (205) is arranged closer to the second recess than the first cross-section (205).

This application is a National Stage completion of PCT/EP2014/074834 filed Nov. 18, 2014, which claims priority from German patent application serial no. 10 2013 226 526.3 filed Dec. 18, 2013.

### FIELD OF THE INVENTION

The invention concerns a planetary carrier in particular for use in a planetary stage of a transmission of a wind turbine.

### BACKGROUND OF THE INVENTION

FIG. 1 shows a planetary carrier 101 known from the prior art, with a recess 103 for holding a planetary bolt 105. The recess 103 is surrounded by a collar 107.

On the outside—in FIG. 1 on the left-hand side—the planetary carrier 101 has a flat surface. The collar 107 projects inward on the inside of the planetary carrier 101.

The recess fixes the planetary bolt 105 in the radial direction in a form-fitting manner.

In the axial direction the planetary bolt 105 is usually fixed by means of a press fit. To produce such a press fit, before the planetary bolt 105 is fitted the planetary carrier 101 is heated. Once the planetary bolt 105 has been inserted into the recess 103, the planetary carrier 101 shrinks when it cools, gripping the planetary bolt 105.

The rigidity of the recess against loading in the radial direction is lower in the area of the collar 107 than in the area of the planetary carrier 101. This results in a deflection of the planetary bolt 105, which is caused by the load of the planetary gear during operation and spread into the recess 103. Thus, the force acting along the bend line has an axial component in the area of the recess 103.

If this axial component exceeds a threshold value, the shrink fit gets loose. This limits the load-bearing ability of the planetary bolt.

### SUMMARY OF THE INVENTION

The purpose of the present invention is to design a planetary carrier in such manner that the disadvantages inherent in the embodiments known from the prior art are avoided. In particular, the load-bearing ability of the planetary bolt should be improved,

A planetary carrier according to the invention comprises at least a first recess and a second recess, each serving to hold a planetary bolt. In particular, the first and second recesses are designed such that together they can hold a single planetary bolt. Thus, the first and second recesses each form a planetary seating. In this context, holding the planetary bolt means that the planetary bolt is introduced into the first and/or the second recess so that the first and/or the second recess holds the planetary bolt fixed. This fixing takes place at least in the axial direction. Preferably, the planetary bolt is also fixed in the radial direction. For that purpose a press-fit is suitable, preferably a shrink fit.

To form the shrink fit, the planetary carrier is heated before the planetary bolt is inserted into the first recess and/or into the second recess. During the subsequent cooling of the planetary carrier, it shrinks onto the planetary bolt. Consequently, a shrink fit forms in the first and/or in the second recess.

The first and second recesses are preferably in each case open hollow spaces, i.e. hollow spaces with at least one open end. Preferably, the hollow space is cylindrical and the opening is therefore circular.

To be able to insert the planetary bolt into the planetary carrier, it is also preferable for one of the two recesses—the first recess or the second recess—to have two openings, through which the planetary bolt can be introduced. Likewise, the other one of the two recesses can also have two openings, but preferably has just one opening. In particular the first recess can have two openings or just one opening. The openings are also referred to as apertures.

The invention is based on the idea of increasing the rigidity of the planetary carrier in the area of the first recess by making the planetary carrier around the first recess more sturdy compared with the second recess. Thus, a cross-section extending at the level of the first recess in the radial direction through the planetary carrier passes through more material compared with the second recess, This is equivalent to a larger area or larger surface area of the cross-section,

According to the invention, correspondingly a first cross-section extending through the planetary carrier in the radial direction, i.e. perpendicularly to the axis of symmetry of the planetary bolt or to the axis of symmetry of the first recess or to the axis of symmetry of the second recess or to the rotational axis of a planetary gearwheel fitted onto the planetary bolt, has a larger surface area than a second cross-section extending in the radial direction through the planetary carrier, The first recess extends both through the first cross-section and through the second cross-section. Thus, the first cross-section and the second cross-section respectively surround a free area that is delimited by the first recess. The first cross-section and the second cross-section enclose the first recess, or extend around the first recess.

Particularly in the axial direction, i.e. in the direction of the symmetry axis of the planetary bolt or the symmetry axis of the first recess or the symmetry axis of the second recess or the rotational axis of a gearwheel fitted onto the planetary bolt, the first cross-section is arranged closer to the second recess than is the second cross-section. This means that in particular in the axial direction, the first cross-section is arranged more toward the second recess than the second cross-section, The second cross-section and the second recess are on different sides of a plane in which the first cross-section lies. Thus, the first cross-section is on the same side as the second recess, of a plane in which the second cross-section lies.

Owing to the larger surface area of the first cross-section, the planetary carrier has more material around the first recess in the direction of the second recess. This increases the rigidity of the planetary carrier against loading in the radial direction, mainly at the level where the planetary bolt is inserted into the first recess. This prevents any deflection of the planetary bolt from spreading into the first recess, Thus, the forces acting upon the press fit in the axial direction are reduced and the load-bearing ability of the planetary bolt is increased.

To reduce the forces acting in the axial direction, it has been found particularly advantageous for the first cross-section to lie in the same plane as an aperture of the first recess. This aperture can be the only aperture of the first recess. Alternatively, the first recess can have two apertures. Since the first cross-section is arranged closer to the second recess than is the second cross-section, in this case the aperture that lies in the same plane as the first cross-section is arranged closer to the second recess than one of the other two apertures. Thus, the other of the two apertures and the second recess are on different sides of the plane. The aperture lying in the same plane as the first cross-section is on the same side as the second aperture, of a plane in which the other of the two apertures lies. In the axial direction, the aperture lying in the same plane as the first cross-section is positioned more toward the second holder than the other of the two apertures.

To hold the planetary bolt, planetary carriers usually have two side-pieces arranged opposite one another. The planetary bolts extend between the side-pieces. In addition, an area is left open between the side-pieces, within which the planetary gearwheels can rotate.

In a particularly preferred embodiment of the invention at least one side-piece is provided, which contributes toward enlarging the area of the first cross-section and thus toward increasing the rigidity in that area. This has the advantage that no additional material is needed.

In this embodiment the side-piece has the first recess. The first cross-section passes at least partially through the side-piece. Preferably, the first cross-section passes completely through the side-piece.

To achieve a uniform pressure distribution in the press fit between the planetary carrier and the planetary bolt, basically planetary seats with a circular cross-section are advantageous. Correspondingly, in a further preferred embodiment the second cross-section is of circular configuration.

By extending the principle of the circular cross-section, an embodiment is obtained in which every third cross-section that passes through the planetary carrier and extends in the radial direction, i.e. perpendicularly to the symmetry axis of the planetary bolt or to the rotational axis of a planetary gearwheel fitted on the planetary bolt, is circular and/or passes at least partially through the side-piece. In particular, the third cross-section passes through the first recess.

A particularly simple structure of the holder of the planetary bolt is obtained if each third cross-section of the type described has the same area. This means that the width or wall thickness of each of these cross-sections is the same.

Also preferred is an embodiment in which at least part of the first recess has the form of a hollow cylinder open at least at one end. A hollow cylinder open at one end is a hollow cylinder with an open end, i.e. a hollow cylinder with one of its ends removed. The hollow cylinder can be open not just at one end but at both ends. Such a hollow cylinder then is then cut away at both ends.

A further part of the first recess is preferably formed by the side-piece. Preferably, the first recess is formed exclusively by the at least one-sided hollow cylinder and the side-piece.

### BRIEF DESCRIPTION OF THE DRAWINGS

Below, an embodiment of the invention is described in more detail with reference to the illustration shown in FIG. 2. FIG. 1 shows an embodiment known from the prior art. The same indexes in the two figures denote the same, or functionally equivalent features.

In detail, the figures show:

FIG. 1: A recess for holding a planetary bolt, with a projecting, collar-shaped structure; and

FIG. 2: A recess for holding a planetary bolt, in the form of a hollow cylinder open at one end.

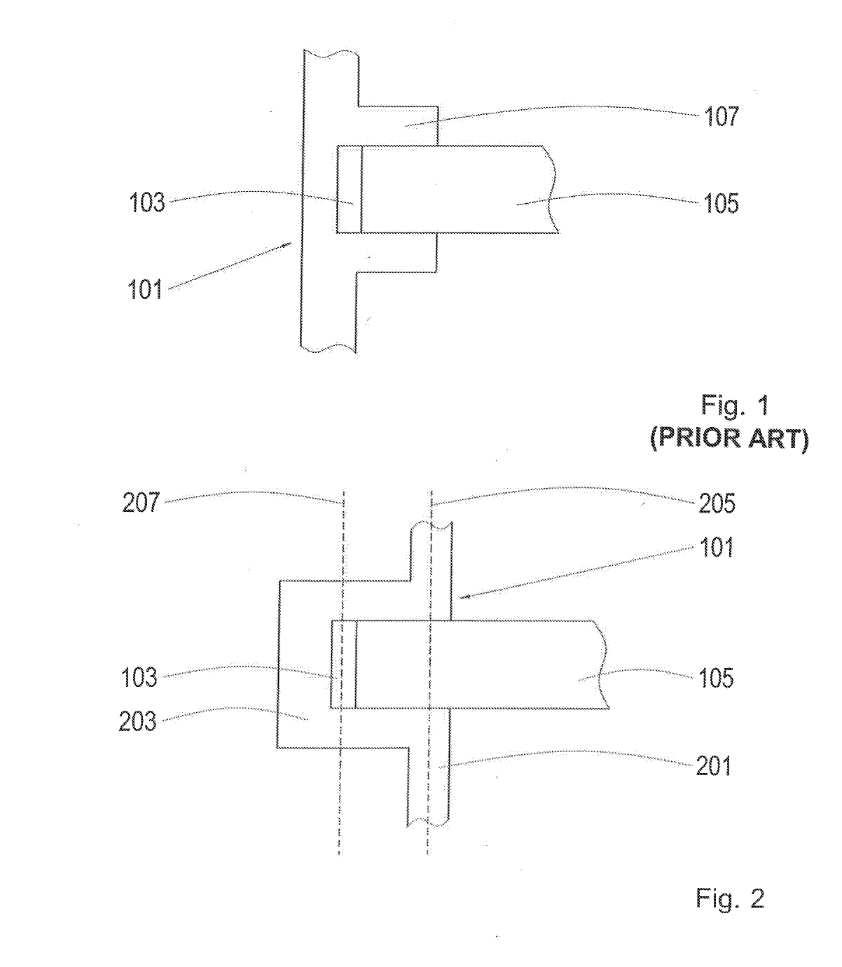

### DETAILED DESCRIPTION OF THE PREFERRED EMBODIMENTS

The planetary carrier 101 shown in FIG. 2 has a side-piece 201 with a hollow cylinder 203 that is open at one end. In the side-piece 201 there is an aperture of circular cross-section. At the aperture, the side-piece 201 merges into the hollow cylinder 203. Thus, together with the inside of the hollow cylinder 203, the aperture in the side-piece 201 forms a recess 103 for holding a planetary bolt 105,

The planetary bolt 105 is arranged inside the planetary carrier 101. Correspondingly, the hollow cylinder 203 is attached on the outside of the planetary carrier 101 and onto its side-piece 201. In particular, the hollow cylinder 203 forms a cup-shaped holder for the planetary bolt 105, such that the cup merges at its edge into the planetary carrier 101 or its side-piece 201.

FIG. 2 also shows a first cross-section 205 extending in the radial direction through the planetary carrier 101 and a second cross-section 207 extending in the radial direction through the planetary carrier 101. The first cross-section 205 passes at least partially through the side-piece 201. The second cross-section 207 passes through the hollow cylinder 203. Consequently, the second cross-section is of circular shape. In particular, the first cross-section 205 has a larger area than the second cross-section 207. Thus, in the area of the first cross-section 205 the rigidity of the structure illustrated, against loading by the planetary bolt 105, is greater than it is in the area of the second cross-section 207.

### INDEXES

101 Planetary carrier

103 Recess

105 Planetary bolt

107 Collar

201 Side-piece

203 Hollow cylinder

205 First cross-section

207 Second cross-section

1-7. (canceled)

8. A planetary carrier (101) comprising:
at least a first recess (103) for holding a planetary bolt (105) and a second recess for holding the planetary bolt (105),
a first cross-section (205) passing, in a radial direction, through the planetary carrier (101) having a larger area than a second cross-section (207) passing in the radial direction through the planetary carrier (101),
the first recess (103) extending through the first cross-section (205) and the second cross-section (207), and
the first cross-section (205) being arranged closer to the second recess than the second cross-section (207).

9. The planetary carrier (101) according to claim 8, wherein the first cross-section (205) lies in a plane containing a first aperture of the first recess (103).

10. The planetary carrier (101) according to claim 8, further comprising:
at least one sidepiece (201) such that the sidepiece (201) comprises the first recess (103), and
the first cross-section (205) passes at east partially through the sidepiece (201).

11. The planetary carrier (101) according to claim 8, wherein the second cross-section (207) is of a circular shape.

12. The planetary carrier (101) according to claim 11, wherein each third cross-section extends, in the radial direction, through the planetary carrier (101), such that the first recess (103) at least one of:
extends through the third cross-section,
is of a circular shape, and
passes at least partially through the side-piece (201).

13. The planetary carrier (101) according to claim 12, wherein each of the third circular cross-sections, which extends in the radial direction through the planetary carrier (101), has a same area.

14. The planetary carrier (101) according to claim 13, wherein
at least part of the first recess (103) is in a form of a hollow cylinder having at least one open end.
